(19) United States
(12) Patent Application Publication
(10) Pub. No.: US 2008/0152172 A1
(43) Pub. Date: Jun. 26, 2008

(54) ELECTROSTATIC ULTRASONIC TRANSDUCER, AND ULTRASONIC SPEAKER, AUDIO SIGNAL REPRODUCTION METHOD, ULTRA-DIRECTIVE SOUND SYSTEM, AND DISPLAY APPARATUS USING ELECTROSTATIC ULTRASONIC TRANSDUCER

(75) Inventor: Kinya MATSUZAWA, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/959,621

(22) Filed: Dec. 19, 2007

(30) Foreign Application Priority Data
Dec. 20, 2006 (JP) 2006-342295

(51) Int. Cl. H04R 3/06; H04R 3/00; H04R 19/02

(52) U.S. Cl. 381/116; 310/309; 381/191

(57) ABSTRACT

An electrostatic ultrasonic transducer includes a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Each of the pair of the electrodes has an electrode portion at a position in the periphery of the through hole. An alternating current signal is applied between the pair of the electrodes and the electrode layer of the oscillation film.

### BACKGROUND

1. Technical Field

The present invention relates to an electrostatic ultrasonic transducer which has high directivity and produces constant high sound pressure throughout a wide frequency band range, and an ultrasonic speaker having high directivity, an audio signal reproduction method, an ultra-directive sound system, and a display apparatus which use this electrostatic ultrasonic transducer.

2. Related Art

Most ultrasonic transducers as sound emitting apparatuses having high directivity in related art are of resonance type which use piezoelectric ceramic.

FIG. 9 illustrates a structure of an ultrasonic transducer in related art. Most ultrasonic transducers in related art are of resonance type which use piezoelectric ceramic as oscillation element. The ultrasonic transducer shown in FIG. 9 uses piezoelectric ceramic as the oscillation element to perform both conversion from electric signals to ultrasonic waves and conversion from ultrasonic waves to electric signals (transmission and reception of ultrasonic waves). The bimorph-type ultrasonic transducer shown in FIG. 9 has two piezoelectric ceramics 61 and 62, a cone 63, a case 64, leads 65 and 66, and a screen 67.

The piezoelectric ceramics 61 and 62 are affixed to each other, and the leads 65 and 66 are connected with the surfaces of the piezoelectric ceramics 61 and 62, respectively, on the side opposite to the affixed surfaces.

The resonance-type ultrasonic transducer utilizes resonance phenomenon of piezoelectric ceramic. Thus, the characteristics in transmission and reception of ultrasonic waves become preferable in a relatively narrow frequency band range around the resonance frequency of the ultrasonic transducer.

Unlike the resonance-type ultrasonic transducer shown in FIG. 9, an electrostatic-type ultrasonic transducer in related art can generate high sound pressure throughout a high frequency band range as a broadband generation type ultrasonic transducer. This electrostatic-type ultrasonic transducer is called pull-type transducer since an oscillation film operates only on the side to be attracted toward a fixed electrode.

FIG. 10 illustrates a specific structure of a broadband generation type ultrasonic transducer (pull type).

The electrostatic-type ultrasonic transducer shown in FIG. 10 uses a dielectric 131 (insulator) such as PET (polyethylene terephthalate resin) having a thickness in the range from about 3 μm to about 10 μm as the oscillator. An upper electrode 132 made from metal foil such as aluminum foil is provided on the upper surface of the dielectric 131 by deposition or other processing to be combined therewith into one body, and a lower electrode 133 made of brass is provided on the lower surface of the dielectric 131 in contact therewith. The lower electrode 133 is connected with a lead 152, and fixed to a base plate 135 made of Bakelite or other material.

The upper electrode 132 is connected with a lead 153, and the lead 153 is connected with a direct current bias power supply 150. The direct current bias power supply 150 constantly applies direct current bias voltage of around 50V to 150V for upper electrode attraction to the upper electrode 132 such that the upper electrode 132 can be attracted toward the lower electrode 133. A signal source 151 is equipped.

The dielectric 131, the upper electrode 132, and the base plate 135, and further metal rings 136, 137 and 138, and a mesh 139 are all caulked by a case 130.

A plurality of small grooves having non-uniform shapes and lengths of several tens to hundreds μm are formed on the lower electrode 133 on the dielectric 131 side. These small grooves form spaces between the lower electrode 133 and the dielectric 131, and thus distribution of capacitances between the upper electrode 132 and the lower electrode 133 minutely varies.

These random small grooves are formed by roughing the surface of the lower electrode 133 by handwork using file. According to the electrostatic-type ultrasonic transducer, a number of capacitances having clearances of different sizes and depths are formed by this method such that the ultrasonic transducer shown in FIG. 9 obtains wide range frequency characteristics as indicated by a curve Q1 in FIG. 10.

According to the ultrasonic transducer having this structure, rectangular wave signals (50 to 150Vp-p) are given between the upper electrode 132 and the lower electrode 133 with direct current bias voltage applied to the upper electrode 132. According to the frequency characteristics of the resonance-type ultrasonic transducer indicated by a curve Q2 in FIG. 11, the central frequency (resonance frequency of piezoelectric ceramic) is 40 kHz, for example, and sound pressure 30 dB smaller than the maximum sound pressure is obtained at frequencies in the range of ±5 kHz from the central frequency at which the maximum sound pressure is generated.

According to the frequency characteristics of the broadband generation type ultrasonic transducer having the above structure, the curve is flat from about 40 kHz to about 100 kHz, and sound pressure in the range of about ±6 dB from the maximum sound pressure at 100 kHz (see JP-A-2000-50387 and JP-A-2000-50392).

As apparent from the above description, the electrostatic-type ultrasonic transducer shown in FIG. 10 is known as a broadband ultrasonic transducer (pull type) capable of generating relatively high sound pressure throughout a wide frequency band unlike the resonance-type ultrasonic transducer shown in FIG. 9.

However, the maximum sound pressure of the electrostatic-type ultrasonic transducer is 120 dB or lower, which is lower than the maximum sound pressure of the resonance-type ultrasonic transducer which generates the maximum sound pressure of 130 dB or higher as shown in FIG. 11. Thus, the sound pressure generated from the electrostatic-type ultrasonic transducer is slightly lower than the necessary level when it is used for an ultrasonic speaker.

The structure of a typical ultrasonic speaker is now explained. The ultrasonic speaker modulates amplitude of signals in an ultrasonic frequency band called as carrier waves by audio signals (signals in audio frequency band) and drives an ultrasonic transducer by using the modulated signals. Thus, sound waves after modulation of ultrasonic waves by audio signals from a signal source are emitted in the air, and self-reproduced into original audio signals in the air by nonlinear of the air.

Since sound waves are waves of condensation and rarefaction which transmit in the medium of the air, the condensed part and the rarefractional part of the air become remarkable during propagation of the modulated ultrasonic waves. In this case, the sound speed increases in the condensed part and decreases in the rarefractional part, and thus distortion of the modulated waves is caused. As a result, the carrier waves (ultrasonic waves) are separated from the audio waves (original audio signals) in waveform, and humans can hear only audio sounds at 20 kHz or lower (original audio signals). This principle is generally called parametric array effect.

For obtaining a sufficient level of this parametric effect, ultrasonic sound pressure of 120 dB or higher is necessary. However, the electrostatic-type ultrasonic transducer is difficult to achieve this level, and a ceramic piezoelectric element such as PZT and a high molecular piezoelectric element such as PVDF are generally used as ultrasonic wave generator.

The piezoelectric element has a sharp resonance point no matter what material it is made of, and is put to practical use as an ultrasonic speaker driven at this resonance frequency. Thus, the frequency range at which high sound pressure can be secured is extremely narrow. It is therefore considered that the piezoelectric element offers a narrow band.

Generally, the maximum audio frequency band of humans is estimated in the range from 20 Hz to 20 kHz with a band range of approximately 20 kHz. In case of the ultrasonic speaker, therefore, it is difficult to precisely demodulate the original audio signals when high sound pressure is not secured throughout the frequency band of 20 kHz in the ultrasonic wave range. However, it is easily understood that precise reproduction (demodulation) in the wide band range throughout 20 kHz is extremely difficult for the resonance-type ultrasonic speaker using the piezoelectric element in the related art.

Actually, the following problems have been arising from the ultrasonic speaker using the resonance-type ultrasonic transducer in the related art: (1) band is narrow and reproduced sound quality is low; (2) the maximum degree of modulation is only about 0.5 since demodulated sound is distorted by excessive amplitude modulation; (3) oscillation of piezoelectric element becomes unstable with split of sound when input voltage is increased (volume is raised), and piezoelectric element is easily broken when voltage is further increased; and (4) arraying, scale enlargement and scale reduction are difficult, and therefore cost increases.

On the other hand, the electrostatic-type ultrasonic transducer (pull type) shown in FIG. 10 can solve almost all the problems arising from the related-art ultrasonic speaker. However, while capable of covering a wide band, the electrostatic-type ultrasonic transducer has such a problem that the absolute sound pressure required for producing sufficient sound volume of the demodulated sound is not enough.

In addition, according to the pull-type electrostatic ultrasonic transducer, electrostatic force attracts only in the direction toward the fixed electrode side, and symmetric oscillations of the oscillation film (corresponding to the upper electrode 132 in FIG. 10) cannot be maintained. Thus, in case of the electrostatic-type ultrasonic transducer used in the ultrasonic speaker, the oscillations of the oscillation film directly generates audio sounds.

The present inventors have already proposed an electrostatic ultrasonic transducer which can emit sound signals having a sound pressure level sufficiently high for obtaining the parametric array effect throughout a wide frequency band (see JP-A-2005-354472). FIGS. 12A and 12B illustrate a structure of the electrostatic ultrasonic transducer shown in this reference. FIG. 12A shows the structure of the electrostatic ultrasonic transducer, and FIG. 12B is a plan view showing the electrostatic ultrasonic transducer apart of which is cut away. As illustrated in FIGS. 12A and 12B, an electrostatic ultrasonic transducer 1 includes a pair of fixed electrodes 10A and 10B containing conductive members made of conductive material and functioning as electrodes, an oscillation film 12 sandwiched between the pair of the fixed electrodes 10A and 10B and having an electrode layer 121, and a holding member (not shown) for holding the pair of the fixed electrodes 10A and 10B and the oscillation film 12.

The oscillation film 12 is formed by an insulator (insulation layer) 120, and has the electrode layer 121 made of conductive material. A direct current bias power supply 16 applies direct current bias voltage having single polarity (either positive polarity or negative polarity) to the electrode layer 121. In addition, mutually phase-inverted alternating current signals 18A and 18B outputted from a signal source 18 are superposed on the direct current bias voltage and applied between the electrode layer 121 and the fixed electrode 10A and between the electrode layer 121 and the fixed electrode 10B, respectively.

Each of the pair of the fixed electrodes 10A and 10B has the same plural number of through holes 14A at the positions opposed to each other via the oscillation film 12. The signal source 18 applies the mutually phase-inversed alternating current signals 18A and 18B between the conductive member and the fixed electrode 10A and between the conductive member and the fixed electrode 10B, respectively. A direct current bias power supply 16 is equipped.

Capacitors are formed between the fixed electrode 10A and the electrode layer 121 and between the fixed electrode 10B and the electrode layer 121. The structures of a controller for controlling the signal source 18 and the direct current bias power supply 16 and a memory unit containing a table showing control characteristics of the controller are not shown in FIGS. 12A and 12B.

According to the electrostatic ultrasonic transducer 1, the oscillation film 12 having the conductive layer 121 is sandwiched between the pair of the fixed electrodes 10A and 10B having the through holes at the opposed positions, and the alternating current signals 18A and 18B are applied to the pair of the fixed electrodes 10A and 10B by the signal source 18 with direct current bias voltage applied to the oscillation film 12 by the direct current bias power supply 16.

This electrostatic ultrasonic transducer is called push-pull type electrostatic ultrasonic transducer. The electrostatic ultrasonic transducer can increase oscillations of the oscillation film to a level sufficient for obtaining the parametric array effect by receiving both electrostatic attractive force and electrostatic repulsive force on the oscillation film sandwiched between the pair of the electrodes at the same time and in the same direction as the direction in accordance with the polarity of the alternating current signals. Moreover, since oscillations are kept symmetric, this electrostatic ultrasonic transducer can generate sound pressure higher than that of the related-art pull-type electrostatic ultrasonic transducer throughout a wide frequency band range.

As mentioned above, the piezoelectric type and the electrostatic type have been proposed as the ultrasonic transducer applied to the sound generation apparatus (such as ultrasonic speaker) having high directivity. The piezoelectric type has a sharp resonance point and thus provides poor sound reproductivity due to difficult broadening of the band (see JP-A-61-296897 and JP-A-2000-287297). On the other hand, the electrostatic type has the oscillation film whose resonance is not sharp, and can broaden the band achieving excellent sound reproductivity (excellent sound quality) by utilizing columnar resonance phenomenon of sound pipes (see JP-A-2005-354472).

In case of the ultrasonic transducer applied to the ultrasonic speaker, the ultrasonic transducer is required to output high sound pressure. Even for the electrostatic-type ultrasonic transducer which generates relatively high sound pressure, further increase in sound pressure has been demanded.

In addition, according to the electrostatic-type ultrasonic transducer, voltage applied between the electrodes needs to be high voltage of 200V or higher to obtain high sound pressure output. Thus, lowering of the voltage is desired.

### SUMMARY

It is an advantage of some aspects of the invention to provide a low power consumption type electrostatic ultrasonic transducer capable of decreasing voltage applied between electrodes to a level lower than that in a related-art ultrasonic transducer and obtaining high sound pressure, and an ultrasonic speaker, an audio signal reproduction method, an ultra-directive sound system, and a display apparatus using this electrostatic ultrasonic transducer.

An electrostatic ultrasonic transducer according to a first aspect of the invention includes a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Each of the pair of the electrodes has an electrode portion at a position in the periphery of the through hole. An alternating current signal is applied between the pair of the electrodes and the electrode layer of the oscillation film. According to descriptions of this specification and claims, the through hole refers to a columnar space penetrating through the first electrode or second electrode in its thickness direction such that sound waves can pass through the through hole.

According to the electrostatic ultrasonic transducer (push-pull-type ultrasonic transducer) having this structure of the first aspect of the invention, the electrode portion is formed at the position in the periphery of the through hole on which electrostatic force needs to act in each of the pair of the electrodes.

In this case, the electrode area of each of the electrodes can be decreased, and the capacitance formed between the electrode layer of the oscillation film and the pair of the electrodes can be reduced. Thus, load impedance of the electrostatic ultrasonic transducer used as capacitive load increases. As a result, current flowing between each of the pair of the electrodes and the electrode layer of the oscillation film in the electrostatic ultrasonic transducer decreases. Thus, voltage required at the time of driving the electrostatic ultrasonic transducer can be lowered, and therefore power consumption reduction can be achieved.

An electrostatic ultrasonic transducer according to a second aspect of the invention includes a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Base members of the pair of the electrodes are made of non-conductive material. Each of the pair of the electrodes has a step on the periphery of the through hole, and the electrode portion is disposed on the surface of the step opposed to the electrode layer of the oscillation film. An alternating current signal is applied between the pair of the electrodes and the electrode layer of the oscillation film.

According to the electrostatic ultrasonic transducer (push-pull-type ultrasonic transducer) having this structure of the second aspect of the invention, the base members of the pair of the electrodes are made of non-conductive material. Each of the pair of the electrodes has the step on the periphery of the through hole, and the electrode portion is disposed on the surface of the step opposed to the electrode layer of the oscillation film.

In this case, the electrode area of each of the electrodes can be decreased, and the capacitance formed between the electrode layer of the oscillation film and the pair of the electrodes can be reduced.

Thus, load impedance of the electrostatic ultrasonic transducer used as capacitive load increases. As a result, current flowing between each of the pair of the electrodes and the electrode layer of the oscillation film in the electrostatic ultrasonic transducer decreases. Thus, voltage required at the time of driving the electrostatic ultrasonic transducer can be lowered, and therefore power consumption reduction can be achieved.

An electrostatic ultrasonic transducer according to a third aspect of the invention includes a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Base members of the pair of the electrodes are made of conductive material. Each of the pair of the electrodes contains the base member having the convexed electrode portion and the through hole, and a non-conductive member having a through hole, and is constructed by fitting the convexed electrode portion of the base member into the through hole of the non-conductive member. An alternating current signal is applied between the pair of the electrodes and the electrode layer of the oscillation film.

According to the electrostatic ultrasonic transducer (push-pull-type ultrasonic transducer) having this structure of the third aspect of the invention, the base members of the pair of the electrodes are made of conductive material. Each of the pair of the electrodes is constructed such that only the electrode portion on which electrostatic force acts is convexed so as to increase the distance between each of the pair of the electrodes and the electrode layer of the oscillation film. Each of the pair of the electrodes contains the base member having the through hole and the non-conductive member having the through hole. The base member and the non-conductive member are combined into one body by fitting the convexed electrode portion of the base member to the through hole of the non-conductive member.

In this case, the distance between the electrode layer of the oscillation film and the electrode layer of each of the pair of the electrodes in the area other than the portion on which electrostatic force acts in the pair of the electrodes can increase. As a result, the capacitance formed between the electrode layer of the oscillation film and the pair of the electrodes can be reduced.

Accordingly, load impedance of the electrostatic ultrasonic transducer used as capacitive load increases. As a result, current flowing between each of the pair of the electrodes and the electrode layer of the oscillation film in the electrostatic ultrasonic transducer decreases. Thus, voltage required at the time of driving the electrostatic ultrasonic transducer can be lowered, and therefore power consumption reduction can be achieved.

An electrostatic ultrasonic transducer according to a fourth aspect of the invention includes a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Each of the pair of the electrodes has an electrode portion at a position inside the through hole. An alternating current signal is applied between the pair of the electrodes and the electrode layer of the oscillation film. According to descriptions of this specification and claims, the portion inside the through hole refers to a portion inside a columnar space penetrating through each of the first electrode and second electrode in its thickness direction such that sound waves can pass through the through hole.

According to the electrostatic ultrasonic transducer (push-pull-type ultrasonic transducer) having this structure of the fourth aspect of the invention, the electrode portion is formed at the position inside the through hole on which electrostatic force needs to act in each of the pair of the electrodes.

In this case, the electrode layer area of each of the pair of the electrodes can be decreased, and the capacitance formed between each of the pair of the electrode layer of the oscillation film and the pair of the electrodes can be reduced. Thus, load impedance of the electrostatic ultrasonic transducer used as capacitive load increases. As a result, current flowing between each of the pair of the electrodes and the electrode layer of the oscillation film in the electrostatic ultrasonic transducer decreases. Thus, voltage required at the time of driving the electrostatic ultrasonic transducer can be lowered, and therefore power consumption reduction can be achieved.

An electrostatic ultrasonic transducer according to a fifth aspect of the invention includes a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Base members of the pair of the electrodes are made of non-conductive material. Each of the pair of the electrodes has the electrode portion disposed on the surface of a bridge-shaped portion of the base member inside the through hole of the electrode and opposed to the electrode layer of the oscillation film. An alternating current signal is applied between the pair of the electrodes and the electrode layer of the oscillation film.

According to the electrostatic ultrasonic transducer (push-pull-type ultrasonic transducer) having this structure of the fifth aspect of the invention, the base members of the pair of the electrodes are made of non-conductive material. Each of the pair of the electrodes has the electrode portion disposed on the surface of the bridge-shaped portion of the base member inside the through hole of the electrode and opposed to the electrode layer of the oscillation film.

In this case, the electrode layer area of each of the pair of the electrodes can be decreased, and the capacitance formed between the electrode layer of the oscillation film and the pair of the electrodes can be reduced.

Thus, load impedance of the electrostatic ultrasonic transducer used as capacitive load increases. As a result, current flowing between each of the pair of the electrodes and the electrode layer of the oscillation film in the electrostatic ultrasonic transducer decreases. Thus, voltage required at the time of driving the electrostatic ultrasonic transducer can be lowered, and therefore power consumption reduction can be achieved.

An electrostatic ultrasonic transducer according to a sixth aspect of the invention includes a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Base members of the pair of the electrodes are made of conductive material. Each of the pair of the electrodes contains the base member having the electrode portion convexed and bridge-shaped at a position opposed to the electrode layer of the oscillation film, and a non-conductive member having a through hole, and is constructed by fitting the convexed electrode portion of the base member into the through hole of the non-conductive member. An alternating current signal is applied between the pair of the electrodes and the electrode layer of the oscillation film.

According to the electrostatic ultrasonic transducer (push-pull-type ultrasonic transducer) having this structure of the sixth aspect of the invention, the base members of the pair of the electrodes are made of conductive material. Each of the pair of the electrodes is constructed such that only the electrode portion on which electrostatic force acts is convexed so as to increase the distance between the electrode and the electrode layer of the oscillation film. Each of the pair of the electrodes contains the base member bridge-shaped so as to oppose to the electrode layer of the oscillation film and the non-conductive member having the through hole. The base member and the non-conductive member are combined into one body by fitting convexed the electrode portion of the base member to the through hole of the non-conductive member.

In this case, the distance between the electrode layer of the oscillation film and the electrode layer of each of the pair of the electrodes in the area other than the portion on which electrostatic force acts in the pair of the electrodes can increase. As a result, the capacitance formed between the electrode layer of the oscillation film and the pair of the electrodes can be reduced.

Accordingly, load impedance of the electrostatic ultrasonic transducer used as capacitive load increases. As a result, current flowing between each of the pair of the electrodes and the electrode layer of the oscillation film decreases. Thus, voltage required at the time of driving the electrostatic ultrasonic transducer can be lowered, and therefore power consumption reduction can be achieved.

An ultrasonic speaker according to a seventh aspect of the invention includes an electrostatic ultrasonic transducer which contains a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Each of the pair of the electrodes has an electrode portion at a position in the periphery of the through hole. An alternating current signal is applied between the pair of the electrodes and the electrode layer of the oscillation film. The ultrasonic speaker further includes a signal source which generates signal waves in an audio frequency band, a carrier wave supply unit which generates and outputs carrier waves in an ultrasonic frequency band, and a modulating unit which modulates the carrier waves by signal waves in an audio frequency band outputted from the signal source. The electrostatic ultrasonic transducer is driven by a modulated signal outputted from the modulating unit and applied between the electrodes and the electrode layer of the oscillation film.

According to the ultrasonic speaker having this structure of the seventh aspect of the invention, the electrode layer of each of the pair of the electrodes included in the electrostatic ultrasonic transducer used in the ultrasonic speaker is formed at the position in the periphery of the through hole on which electrostatic force needs to act. In this case, the electrode layer area of each of the pair of the electrodes can be decreased, and the capacitance formed between the electrode layer of the oscillation film and the pair of the electrodes can be reduced. Thus, load impedance of the electrostatic ultrasonic transducer used as capacitive load increases. As a result, current flowing between each of the pair of the electrodes and the electrode layer of the oscillation film in the electrostatic ultrasonic transducer decreases. Thus, voltage required at the time of driving the electrostatic ultrasonic transducer can be lowered, and therefore power consumption reduction can be achieved. That is, sound pressure equivalent to that generated by the ultrasonic speaker in the related art can be produced by smaller energy, and therefore power consumption reduction of the ultrasonic speaker can be achieved.

An audio signal reproduction method according to an eighth aspect of the invention uses an electrostatic ultrasonic transducer which contains a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Each of the pair of the electrodes has an electrode layer at a position in the periphery of the through hole. An alternating current signal is applied between the pair of the electrodes and the electrode layer of the oscillation film. The audio signal reproduction method includes a step of generating signal waves in an audio frequency band from a signal source, a step of generating and outputting carrier waves in an ultrasonic wave frequency band from a carrier wave supply unit, a step of generating a modulated signal produced by modulation of the carrier waves by the signal waves in the audio frequency band using modulating unit, and a step of driving the electrostatic ultrasonic transducer by applying the modulated signal between the electrodes and the electrode layer of the oscillation film.

According to the audio signal reproduction method including these steps for the electrostatic ultrasonic transducer, the signal waves in the audio frequency band are generated by the signal source, and the carrier waves in the ultrasonic wave frequency band are generated and outputted by the carrier wave supply source. Then, the carrier waves are modulated by the signal waves in the audio frequency band using the modulating unit. Thereafter, the modulated signals are applied between the electrodes and the electrode layer of the oscillation film to drive the electrostatic ultrasonic transducer.

According to this structure having the electrostatic ultrasonic transducer constructed as above, voltage applied between the electrodes is lowered and the oscillations of the film are increased. As a result, sound signals at a sound pressure level sufficiently high to obtain the parametric array effect throughout a wide frequency band range can be outputted to reproduce sound signals.

An ultra-directive sound system according to a ninth aspect of the invention includes uses an ultrasonic speaker including an electrostatic ultrasonic transducer which contains a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Each of the pair of the electrodes has an electrode layer at a position in the periphery of the through hole. An alternating current signal is applied between the pair of the electrodes and the electrode layer of the oscillation film. The ultrasonic speaker reproduces audio signals in middle-tone and high-tone ranges in audio signals supplied from a sound source. The ultra-directive sound system further includes a low-tone reproduction speaker which reproduces audio signals in a low-tone range in the audio signals supplied from the sound source. The ultrasonic speaker reproduces audio signals supplied from the sound source to form a virtual sound source in the vicinity of a sound wave reflection surface such as screen.

According to the ultra-directive sound system having this structure, the ultrasonic speaker including the electrostatic ultrasonic transducer which contains the first electrode having the through hole, the second electrode having the through hole, and the oscillation film disposed such that the through hole of the first electrode can be paired with the through hole of the second electrode and sandwiched between the pair of the first electrode and second electrode is used. The oscillation film has the electrode layer to which direct current bias voltage is applied. Each of the pair of the electrodes has the electrode layer at a position in the periphery of the through hole. An alternating current signal is applied between the pair of the electrodes and the electrode layer of the oscillation film. The ultrasonic speaker reproduces audio signals in the middle-tone and high-tone ranges in audio signals supplied from the sound source, and the low-tone reproduction speaker reproduces audio signals in the low-tone range in the audio signals supplied from the sound source.

Thus, the sounds in the middle-tone and high-tone ranges having sufficient sound pressure and broadband characteristics can be generated from the virtual sound source formed in the vicinity of the sound wave reflection surface such as screen under the condition where the voltage applied between the electrodes of the electrostatic ultrasonic transducer is lowered with improvement over the sound pressure characteristics. Moreover, since sounds in the low-tone range are directly outputted from the low-tone reproduction speaker equipped on the sound system, the low tone range can be strengthened. As a result, sound environment capable of providing a more preferable feeling of being at a live performance can be created.

A display apparatus according to a tenth aspect of the invention includes uses an ultrasonic speaker including an electrostatic ultrasonic transducer which contains a first electrode having a through hole, a second electrode having a through hole, and an oscillation film disposed such that the through hole of the first electrode can be paired with the through hole of the second electrode and sandwiched between the pair of the first electrode and second electrode. The oscillation film has an electrode layer to which direct current bias voltage is applied. Each of the pair of the electrodes has an electrode layer at a position in the periphery of the through hole. An alternating current signal is applied between the pair of the electrodes and the electrode layer of the oscillation film. The ultrasonic speaker reproduces signal sounds in an audio frequency band from audio signals supplied from a sound source. The display apparatus further includes a projection optical system which projects an image on a projection surface.

According to the display apparatus having this structure, the ultrasonic speaker including the electrostatic ultrasonic transducer which contains the first electrode having the through hole, the second electrode having the through hole, and the oscillation film disposed such that the through hole of the first electrode can be paired with the through hole of the second electrode and sandwiched between the pair of the first electrode and second electrode is used. The oscillation film has the electrode layer to which direct current bias voltage is applied. Each of the pair of the electrodes has the electrode layer at a position in the periphery of the through hole. An alternating current signal is applied between the pair of the electrodes and the electrode layer of the oscillation film. The audio signals supplied from the sound source are reproduced by the ultrasonic speaker.

According to this structure, the sound signals having sufficient sound pressure and broadband characteristics can be generated from a virtual sound source formed in the vicinity of a sound wave reflection surface such as screen with improvement over the sound pressure characteristics. Thus, the reproduction range of the sound signals can be easily controlled. Moreover, the directivity of sounds emitted from the ultrasonic speaker can be controlled.

### BRIEF DESCRIPTION OF THE DRAWINGS

The invention will be described with reference to the accompanying drawings, wherein like reference numbers are given to like elements.

FIGS. 1A and 1B illustrate a structure of an electrostatic ultrasonic transducer according to an embodiment of the invention.

FIG. 2A is a plan view of a structure example of a fixed electrode included in the electrostatic ultrasonic transducer shown in FIGS. 1A and 1B.

FIGS. 2B and 2C are cross-sectional views of the structure of the fixed electrode shown in FIG. 2A.

FIG. 3A is a plan view of another structure example of the fixed electrode included in the electrostatic ultrasonic transducer shown in FIGS. 1A and 1B.

FIGS. 3B and 3C are cross-sectional views of the structure of the fixed electrode shown in FIG. 3A.

FIG. 4 illustrates a structure example of an ultrasonic speaker.

FIG. 5 illustrates a use condition of a projector according to an embodiment of the invention.

FIGS. 6A and 6B illustrate an external appearance of the projector shown in FIG. 5.

FIG. 7 is a block diagram showing an electric structure of the projector shown in FIG. 5.

FIG. 8 illustrates a reproduction condition of reproduction signals generated by the ultrasonic transducer.

FIG. 9 illustrates a structure of a resonance-type ultrasonic transducer in related art.

FIG. 10 illustrates a specific structure of an electrostatic wideband generation type ultrasonic transducer in related art.

FIG. 11 shows frequency characteristics of the electrostatic ultrasonic transducer according to the embodiment of the invention and frequency characteristics of the ultrasonic transducer in the related art.

FIGS. 12A and 12B illustrate a structure example of an electrostatic ultrasonic transducer in related art.

### DESCRIPTION OF EXEMPLARY EMBODIMENTS

Embodiments according to the invention are hereinafter described with reference to the drawings.

### Structure Example of Electrostatic Transducer Embodying the Invention

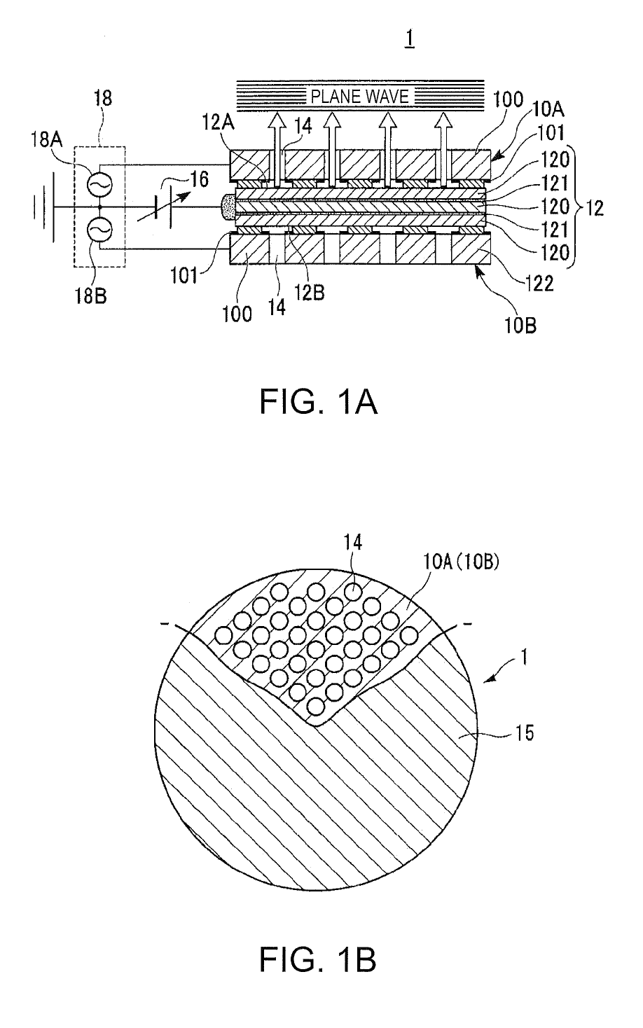

FIGS. 1A and 1B illustrate a structure of an electrostatic ultrasonic transducer according to a first embodiment of the invention. FIG. 1A shows the structure of the electrostatic ultrasonic transducer, and FIG. 1B is a plan view of the ultrasonic transducer a part of which is cut away.

As illustrated in FIGS. 1A and 1B, an electrostatic ultrasonic transducer 1 according to the first embodiment of the invention includes a fixed electrode 10A (first electrode) having through holes 14, a fixed electrode 10B (second electrode) having through holes each of which is paired with the corresponding one of the through holes 14 of the fixed electrode 10A, an oscillation film 12 sandwiched between the pair of the fixed electrodes 10A and 10B and having electrode layers 121, and a holding member (not shown) for holding the pair of the fixed electrodes 10A and 10B and the oscillation film.

The oscillation film 12 has an insulator (insulation layer) 120. The electrode layers 121 made of conductive material are provided in the intermediate positions of the insulator (insulation layer) 120. More specifically, the oscillation film 12 is formed by laminating high molecular films (insulators) each of which has a thickness of several microns and one metallized surface, and bonding these films by adhesive. Examples of material used for the high molecular films involve polyethylene terephthalate (PET), aramid, polyester, polyethylene naphthalate (PEN), polyphenylene sulfide (PPS), and others. The most typical material used for metallizing the films is aluminum, but Ni, Cu, SUS, Ti and others may be used.

The thickness of the metallization is preferably in the range from about 500 angstroms to about 1,500 angstroms.

A direct current bias power supply 16 applies direct current bias voltage having single polarity (positive polarity in this embodiment, but either positive polarity or negative polarity may be used) to the electrode layers 121. In this case, direct current bias voltage of 50 to 300V is applied to the metallized portion (electrode layer 121) of the oscillation film 12 from the circuit.

Also, mutually phase-inversed alternating current signals 18A and 18B outputted from a signal source 18 are superposed on the direct current bias voltage and applied between the fixed electrode 10A and the plural electrode layers 121 and between the fixed electrode 10B and the plural electrode layers 121, respectively.

Each of the pair of the fixed electrodes 10A and 10B has the same number of the plural through holes 14 at positions opposed to the corresponding through holes 14 via the oscillation film 12. Base members 100 of the pair of the fixed electrodes 10A and 10B are made of non-conductive material. Each of the pair of the fixed electrodes 10A and 10B has steps around the peripheries of the through holes 14 of the electrodes 10A and 10B. An electrode layer 101 made of conductive material is provided on each step surface of the electrodes 10A and 10B on the side opposed to the electrode layers 121 of the oscillation film 12.

Examples of the non-conductive material used for the base material of the pair of the fixed electrodes 10A and 10B include glass, glass fiber materials, plastics, hard rubber and the like. Examples of the conductive materials used for forming the electrode layers 101 include copper, aluminum, nickel, gold, silver, chrome and the like. The electrode layers 101 are formed on the step surfaces of the pair of the electrodes 10A and 10B made from the base materials by plating, deposition, printing, and other methods.

The signal source 18 applies the mutually phase-inversed alternating current signals 18A and 18B between the fixed electrode 10A and the electrode layer 121 of the oscillation film 12 and between the fixed electrode 10B and the electrode layer 121 of the oscillation film 12. In this case, the alternating current voltage (alternating current signal) in the range from about 10V to about 300V is applied to the pair of the fixed electrodes 10A and 10B from the circuit. A direct current bias power supply 16 is equipped.

Capacitors are formed between the fixed electrode 10A and the electrode layer 121 and between the fixed electrode 10B and the electrode layer 121. Structures of a controller for controlling the signal source 18 and the direct current bias power supply 16 and a memory unit containing a table indicating the control characteristics of the controller are not shown in FIGS. 1A and 1B.

According to the ultrasonic transducer 1 having this structure, the direct current bias power supply 16 applies direct current bias voltage having single polarity (positive polarity in this embodiment) to the electrode layers 121 of the oscillation film 12. In this case, the mutually phase-inversed alternating current signals 18A and 18B outputted from the signal source 18 are superposed on the direct current bias voltage and applied.

Also, the signal source 18 applies the mutually phase-inversed alternating current signals 18A and 18B between the fixed electrode 10A and the oscillation film 12 and between the fixed electrode 10B and the oscillation film 12, respectively.

As a result, positive voltage is applied to the fixed electrode 10A in the positive half cycle of the alternating current signal 18A outputted from the signal source 18. Thus, electrostatic repulsive force acts on a front surface portion 12A of the oscillation film 12 as the area not held by the fixed electrode, and the front surface portion 12A is pulled downward in FIG. 1A.

At this time, the alternating current signal 18B comes to the negative cycle, and negative voltage is applied to the opposed fixed electrode 10B. As a result, electrostatic attractive force acts on a back surface portion 12B on the back side of the front surface portion 12A of the oscillation film 12. Thus, the back surface portion 12B is pulled further downward in FIG. 1A.

Accordingly, the film portions as the areas of the oscillation film 12 not sandwiched between the pair of the fixed electrodes 10A and 10B receive both electrostatic attractive force and electrostatic repulsive force in the same direction. During the negative half cycle of the alternating current signals outputted from the signal source 18, electrostatic attractive force similarly acts on the front surface portion 12A of the oscillation film 12 in the upward direction in FIG. 1A, and electrostatic repulsive force acts on the back surface portion 12B of the oscillation film 12 in the upward direction in FIG. 1A. The film portions of the oscillation film 12 as the areas not sandwiched between the pair of the fixed electrodes 10A and 10B receive both electrostatic attractive force and electrostatic repulsive force in the same direction. Thus, the acting direction of electrostatic force alternately changes in accordance with the change of polarity of the alternating current signals while the oscillation film 12 is receiving the electrostatic attractive force and electrostatic repulsive force in the same direction. Accordingly, sound signals having a sound pressure level sufficient for obtaining large film oscillations, that is, for obtaining the parametric array effect can be generated.

According to the electrostatic ultrasonic transducer 1 in the embodiment of the invention described above, the oscillation film 12 oscillates by receiving forces from the pair of the fixed electrodes 10A and 10B. Thus, the electrostatic ultrasonic transducer 1 is called push-pull type.

The electrostatic ultrasonic transducer 1 according to this embodiment of the invention has a capacity of simultaneously providing a wider band and higher sound pressure than those of the related-art electrostatic-type ultrasonic transducer (pull type) which utilizes only electrostatic attractive force acting on the oscillation film.

FIG. 11 shows the frequency characteristics of the ultrasonic transducer according to this embodiment of the invention. In this figure, a curve Q3 indicates the frequency characteristics of the ultrasonic transducer according to this embodiment. As can be seen from the figure, a high sound pressure level can be obtained in a wider frequency band than in the case of the frequency characteristics of the broadband-type electrostatic ultrasonic transducer in the related art. More specifically, it is apparent that the sound pressure level of 120 dB or higher sufficient for the parametric effect can be obtained in the frequency band range from 20 kHz to 120 kHz.

According to the ultrasonic transducer 1 in this embodiment of the invention, the thin oscillation film 12 sandwiched between the pair of the electrodes 10A and 10B receives both electrostatic attractive force and electrostatic repulsive force. This structure secures not only generation of large oscillations but also the symmetry of the oscillations. Thus, high sound pressure can be produced throughout a wide band.

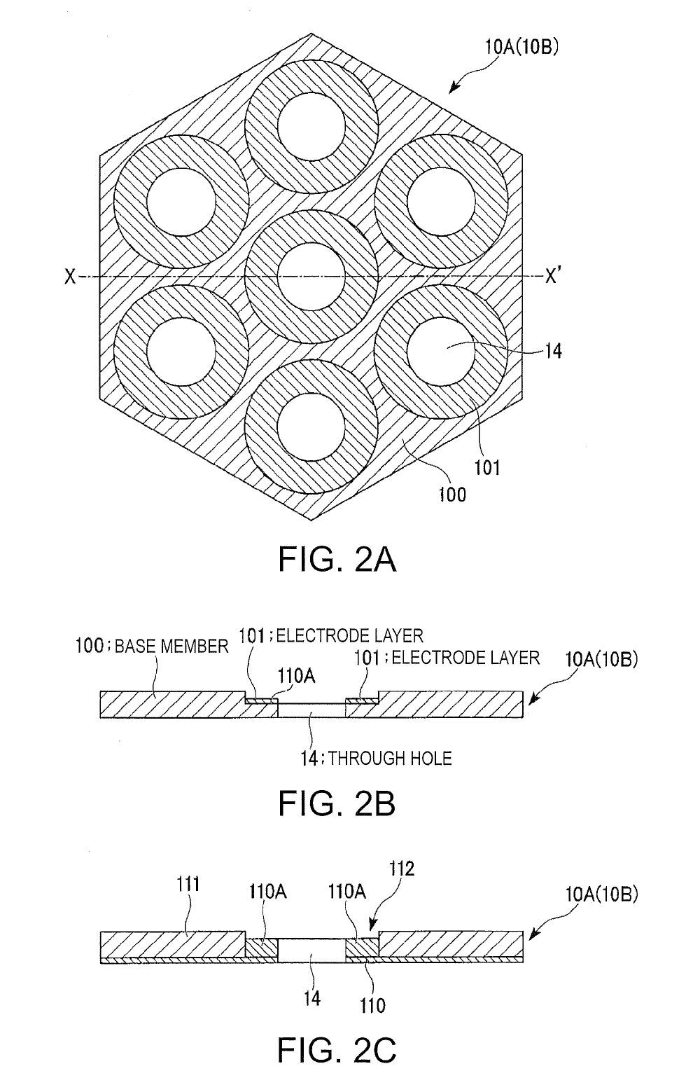

FIGS. 2A through 2C illustrate an example of the structures of the fixed electrodes 10A (first electrode) and the fixed electrode 10B (second electrode) shown in FIGS. 1A and 1B corresponding to the characteristics of the invention. FIG. 2A is a plan view of one side of the fixed electrode 10A (or 10B), FIG. 2B is a cross-sectional view taken along a line X-X′ in FIG. 2A, and FIG. 2C is a cross-sectional view showing a structure of another example taken along the line X-X′ in FIG. 2A. In FIGS. 2A through 2C, only seven through holes through which sound is emitted are shown for simplifying the explanation. As illustrated in FIGS. 2A through 2C, the base member 100 made of non-conductive material is processed such that steps 100A are formed on the base member 100 around the peripheries of the through holes 14, and the electrode layers 101 are provided on the surfaces of the steps 10A.

The base member is processed by an appropriate method such as pressing, injection molding, and machining selected according to the material to be used. According to the related art, not only the electrode layer but also the base member is made of conductive material. In this case, the capacity values of the capacitances formed between the fixed electrode 10A and the electrode layer 121 of the oscillation film 12 and between the fixed electrode 10B and the electrode layer 121 are large, and thus reduction of power consumption is difficult.

According to the first embodiment of the invention, the base member is formed by non-conductive material. In this case, the electrode area is decreased, and thus the capacity values of the capacitances discussed above can be reduced. As a result, the power consumption required at the time of actuation of the electrostatic ultrasonic transducer can be lowered.

When the electrode structure shown in FIGS. 2A and 2B has the radius of the through hole 14 of φ0.75 mm, the outside diameter of the electrode layer 101 of φ1.5 mm, and the through hole pitch of 1.625 mm, the capacity value of the capacitance can achieve 20% reduction by constituting the base member 100 by non-conductive material. In this case, 20% of current can be reduced, and current flowing when voltage equivalent to that in the related art is applied between the electrode layers 121 of the oscillation film 12 and the pair of the fixed electrodes 10A and 10B can be decreased to 80% of that in the case of the related art. Accordingly, the power consumption can be lowered to 80% of that of the related art.

FIG. 2C shows a cross-sectional structure of the electrode taken along the line X-X′ in FIG. 2A in another example (modified example of the first embodiment). The structure in the parts other than the fixed electrodes of the electrostatic ultrasonic transducer is basically the same as those shown in FIGS. 1A and 1B, and thus the structure according to this modified example is explained with reference to FIGS. 1A and 1B and FIG. 2C. This modified example is another example of the electrode structure for reducing the capacity values of the capacitances formed between the pair of the fixed electrodes 10A and 10B and the electrode layers 121 of the oscillation film 12. As illustrated in FIG. 2C, base members 110 of the pair of the fixed electrodes 10A and 10B are made of conductive material unlike the structure shown in FIGS. 1A and 1B. Each of the pair of the fixed electrodes 10A and 10B has the base member 110 which includes electrode portions 110A having the through holes 14 as only convex portions on which electrostatic force acts to increase the distance from the electrode layer 121 of the oscillation film 12. Each of the pair of the fixed electrodes 10A and 10B also has a non-conductive portion 111 on which through holes 112 are formed. The base member 110 and the non-conductive portion 111 are combined into one body by fitting the convexed electrode portion 110A of the base member 110 to the through holes 112 of the non-conductive portion 111 to form each of the pair of the electrodes 10A and 10B. The structure in other parts is similar to that shown in FIGS. 1A and 1B and FIG. 2A.

In the case of the electrode structure of the fixed electrodes 10A and 10B shown in FIG. 2C discussed above, the distance between the electrode layer 121 of the oscillation film (see FIGS. 1A and 1B) and the electrode layer (electrode portion 110A) of each of the pair of the fixed electrodes 10A and 10B at the portion other than the portion on which electrostatic force acts in the pair of the fixed electrodes 10A and 10B can be increased. Thus, the capacitances formed between the pair of the fixed electrodes and the electrode layers of the oscillation film can be reduced.

Accordingly, load impedance of the electrostatic ultrasonic transducer used as capacitive load becomes large. As a result, current flowing between each of the pair of the electrodes and the electrode layer of the oscillation film in the electrostatic ultrasonic transducer decreases. Thus, voltage required at the time of driving the electrostatic ultrasonic transducer can be lowered, and therefore power consumption reduction can be achieved.

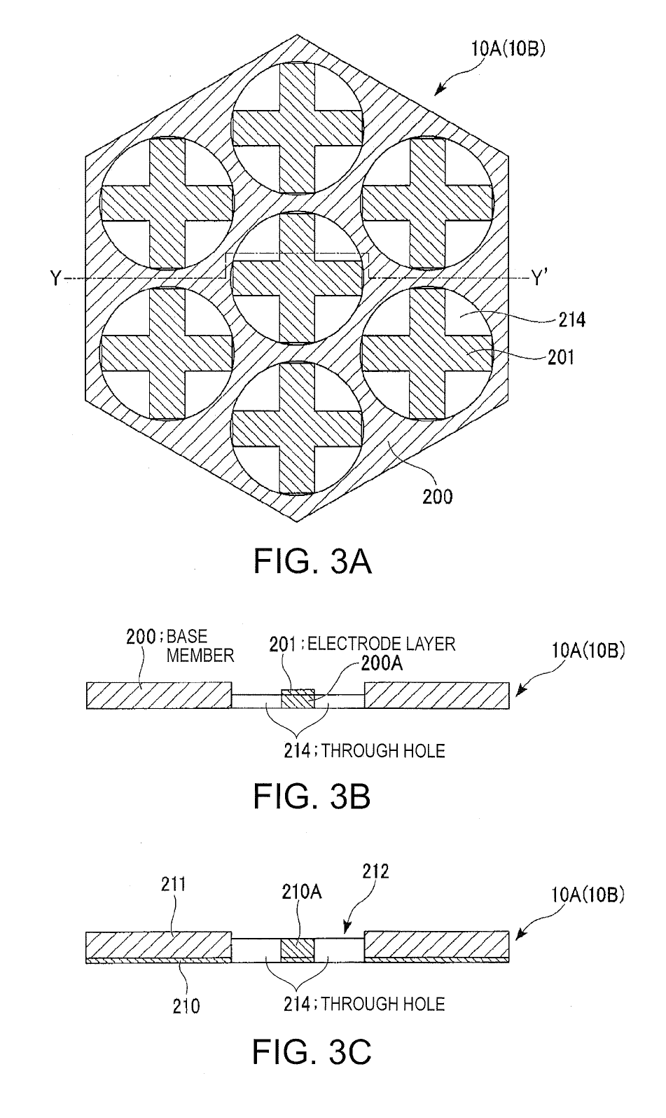

An electrostatic ultrasonic transducer according to a second embodiment of the invention is now described. The structure of the electrostatic ultrasonic transducer according to the second embodiment of the invention is basically the same as that of the electrostatic ultrasonic transducer according to the first embodiment except for the structure of the pair of the fixed electrodes 10A and 10B. Thus, the electrostatic ultrasonic transducer according to the second embodiment is explained with reference to FIGS. 1A and 1B and FIGS. 3A through 3C. FIGS. 3A through 3C illustrate the structure of the fixed electrodes included in the electrostatic ultrasonic transducer according to the second embodiment of the invention. FIG. 3A is a plan view of one side of the fixed electrode 10A (or 10B), FIG. 3B is a cross-sectional view taken along a line Y-Y′ in FIG. 3A, and FIG. 3C is a cross-sectional view showing a structure of another example taken along the line Y-Y′ in FIG. 3A.

As illustrated in FIGS. 1A and 1B and FIGS. 3A and 3B, base members 200 of the pair of the fixed electrodes 10A and 10B are made of non-conductive material. Electrode layers 201 are provided on the surfaces of base member portions 200A formed in the bridge shape and disposed inside through holes 214 of the pair of the fixed electrodes 10A and 10B in such positions as to be opposed to the electrode layers 121 of the oscillation film 12.

According to this structure, the electrode layer areas of the pair of the fixed electrodes included in the electrostatic ultrasonic transducer can be decreased. Thus, the capacitance formed between the pair of the electrodes and the electrode layers of the oscillation film can be reduced.

Accordingly, load impedance of the electrostatic ultrasonic transducer used as capacitive load becomes large. As a result, current flowing between each of the pair of the electrodes and the electrode layer of the oscillation film in the electrostatic ultrasonic transducer decreases. Thus, voltage required at the time of driving the electrostatic ultrasonic transducer can be lowered, and therefore power consumption reduction can be achieved.

FIG. 3C illustrates the cross-sectional structure of the electrode taken along the line Y-Y′ in FIG. 3A according to another example (modified example of second embodiment). As illustrated in FIGS. 1A and 1B and FIG. 3C, base members 210 of the pair of the fixed electrodes 10A and 10B included in the electrostatic ultrasonic transducer 1 are made of conductive material. The base member 210 of each of the pair of the fixed electrodes 10A and 10B has an electrode portion 210A formed in the bridge shape and disposed in such a position as to be opposed to the electrode layers 121 of the oscillation film 12. The electrode portion 210A is an area as the only convex portion on which electrostatic force acts to increase the distance from the electrode layer 121 of the oscillation film 12. Each of the pair of the fixed electrodes 10A and 10B also has a non-conductive portion 211 on which through holes 212 are formed. The base member 210 and the non-conductive portion 211 can be combined into one body by fitting the convexed electrode portions 210A of the base member 210 to the through holes 212 of the non-conductive portion 211 to form each of the pair of the fixed electrodes 10A and 10B.

According to the pair of the fixed electrodes 10A and 10B having this structure, the distance between the electrode layers 121 of the oscillation film 12 and the electrode layer (electrode portion 210A) of each of the pair of the fixed electrodes 10A and 10B at the portion other than the portion on which electrostatic force acts in the pair of the fixed electrodes 10A and 10B can be increased. Thus, the capacitances formed between the pair of the fixed electrodes 10A and 10B and the electrode layers 121 of the oscillation film 12 can be reduced.

Accordingly, load impedance of the electrostatic ultrasonic transducer used as capacitive load becomes large. As a result, current flowing between each of the pair of the electrodes and the electrode layer of the oscillation film decreases. Thus, voltage required at the time of driving the electrostatic ultrasonic transducer can be lowered, and therefore power consumption reduction can be achieved.

According to the electrostatic ultrasonic transducer (push-pull-type ultrasonic transducer) in these embodiments of the invention discussed above, the electrode layers are provided on the peripheral or inside areas of the through holes on which electrostatic force needs to act for each of the pair of the electrodes (fixed electrodes).

In this structure, the electrode layer areas of the pair of the electrodes can be decreased, and the capacitances formed between the pair of the electrodes and the electrode layers of the oscillation film can be reduced.

Accordingly, load impedance of the electrostatic ultrasonic transducer used as capacitive load becomes large. As a result, current flowing between each of the pair of the electrodes and the electrode layer of the oscillation film decreases. Thus, voltage required at the time of driving the electrostatic ultrasonic transducer can be lowered, and therefore power consumption reduction can be achieved.

While the electrode layers (electrode portions) are formed on the base members made of either non-conductive material or conductive material in the examples shown in FIGS. 3A, 3B and 3C, bridge-shaped electrodes may be provided in such a manner as to cross the through holes without using the base members constituting the electrodes. In this case, advantages similar to those in the second embodiment can be offered.

### Structure Example of Ultrasonic Speaker According to the Invention

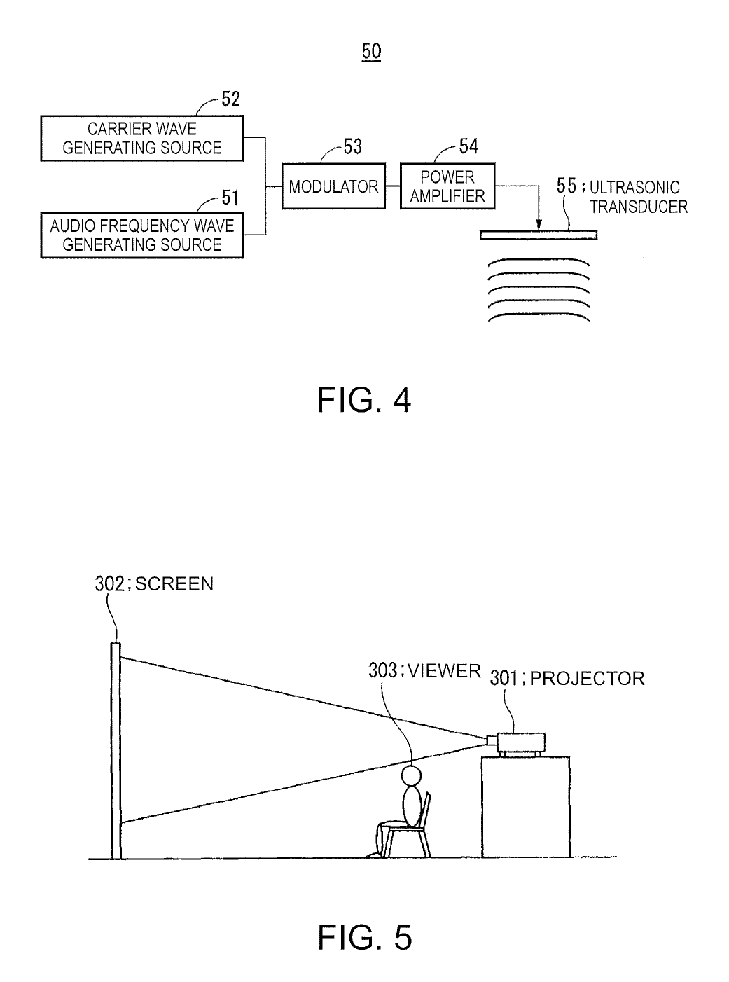

A structure of an ultrasonic speaker according to an embodiment of the invention is now explained with reference to FIG. 4. The ultrasonic speaker according to this embodiment includes an ultrasonic transducer 55 constituted by the electrostatic ultrasonic transducer according to the above embodiment of the invention (see FIGS. 1A and 1B).

As illustrated in FIG. 4, an ultrasonic speaker 50 according to this embodiment includes an audio frequency wave generating source (signal source) 51 which generates signal waves in an audio frequency wave band, a carrier wave generating source (carrier wave supply unit) 52 which generates and outputs carrier waves in an ultrasonic frequency band, a modulator (modulating unit) 53, a power amplifier 54, the ultrasonic transducer (electrostatic ultrasonic transducer) 55.

The modulator 53 modulates carrier waves outputted from the carrier wave generating source 52 by signal waves outputted from the audio frequency wave generating source 51, and supplies the modulated waves to the ultrasonic transducer 55 via the power amplifier 54.

According to this structure, the carrier waves in the ultrasonic frequency band outputted from the carrier wave generating source 52 are modulated by the signal waves outputted from the audio frequency wave generating source 51 using the modulator 53, and the ultrasonic transducer 55 is driven by the modulated signals amplified by the power amplifier 54. As a result, the modulated signals are converted into sound waves at a finite amplitude level by the ultrasonic transducer 55, and the obtained sound waves are emitted into a medium (air). Then, signal sounds in the original audio frequency band are self-reproduced by non-linear effect of the medium (air).

Since sound waves are waves of condensation and rarefaction propagating in the medium of the air, the condensed part and the rarefractional part of the air become remarkable during propagation of the modulated ultrasonic waves. In this case, the sound speed increases in the condensed part and decreases in the rarefractional part, and thus distortion of the modulated waves is caused. As a result, the signal waves (signal sounds) in the audio frequency band are separated from the carrier waves (in the ultrasonic frequency band) in waveform and reproduced.

The structure capable of providing a broadband of high sound pressure is applicable to speakers used for various purposes. Ultrasonic waves greatly damp in the air in proportion to the square of frequency of ultrasonic waves. Thus, when the carrier frequency (ultrasonic waves) is low, damping decreases and the ultrasonic speaker can emit sounds as beams for a long distance.

When the carrier frequency is high, damping increases and causes insufficient parametric effect. In this case, the ultrasonic speaker can expand sounds widely. These functions are highly advantageous since the ultrasonic speaker can be used for various purposes.

Dogs which often share the environment of living with humans as pets can hear sounds at frequencies up to 40 kHz, while cats as similar pets can hear sounds up to 100 kHz. Thus, when carrier frequencies higher than this level are used, effects on the pets can be eliminated. In any cases, a number of advantages are provided if the ultrasonic speaker can be used at various frequencies.

The ultrasonic speaker according to this embodiment of the invention can generate sound signals having sufficient high sound pressure level for obtaining the parametric array effect throughout a wide frequency band range.

Moreover, the ultrasonic speaker having this structure according to the invention includes the electrode layers of the pair of the electrodes contained in the electrostatic ultrasonic transducer used in the ultrasonic speaker, which electrode layers are disposed in the peripheral or inside areas of the through holes where electrostatic force needs to act. Thus, the electrode areas of the pair of the electrodes can be decreased, and the capacitances formed between the pair of the electrodes and the electrode layers of the oscillation film can be reduced. Accordingly, load impedance of the electrostatic ultrasonic transducer used as capacitive load becomes large. As a result, current flowing between each of the pair of the electrodes and the electrode layers of the oscillation film decreases. Thus, voltage required at the time of driving the electrostatic ultrasonic transducer can be lowered, and therefore power consumption reduction can be achieved. That is, the same sound pressure as that of the ultrasonic speaker in related-art can be generated with less energy, and power consumption reduction of the ultrasonic speaker can be achieved.

### Explanation of Structure Example of Ultra-Directive Sound System According to the Invention

An ultra-directive sound system which uses the ultrasonic speaker including the electrostatic ultrasonic transducer according to the invention is now explained. The ultrasonic transducer used herein is a push-pull-type electrostatic ultrasonic transducer which has the first electrode having the through holes, the second electrode having the through holes paired with the through holes of the first electrode, and the oscillation film sandwiched between the pair of the first and second electrodes. The oscillation film has the electrode layer to which direct current bias voltage is applied. Electrode layers are provided in the peripheral or inside areas of the through holes of the pair of the electrodes. Alternating current signals are applied between the pair of the electrodes and the electrode layer of the oscillation film.

An example of the ultra-directive sound system according to the invention applied to a projector is now discussed. The ultra-directive sound system according to the invention is not limited to a projector but may be applied to various types of display which reproduce sounds and images.

FIG. 5 illustrates a use condition of the projector according to the invention. As illustrated in the figure, a projector 301 is positioned behind a viewer 303, and images are projected on a screen 302 disposed before the viewer 303. An ultrasonic speaker provided on the projector 301 forms a virtual sound source on the projection surface of the screen 302 to reproduce audio sounds.

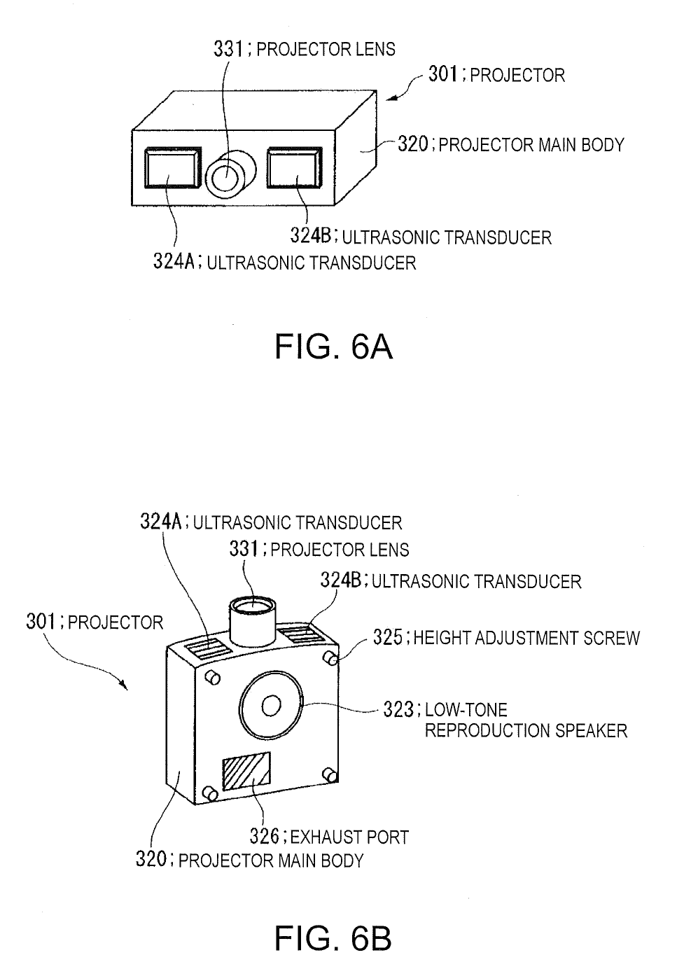

FIGS. 6A and 6B illustrate an external structure of the projector 301. The projector 301 includes a projector main body 320 containing a projection optical system which projects images on the projection surface such as a screen, and an ultrasonic speaker which has ultrasonic transducers 324A and 324B for generating sound waves in an ultrasonic frequency band and reproduces signal sounds at in an audio frequency band from audio signals supplied from a sound source. The projector main body 320 and the ultrasonic speaker are combined as a one body. According to this embodiment, the ultrasonic transducers 324A and 324B constituting the ultrasonic speaker are disposed in the left and right parts of the projector main body with a projector lens 331 of the projection optical system interposed between the ultrasonic transducers 324A and 324B to reproduce stereo audio signals.

A low-tone sound reproduction speaker 323 is provided on the bottom surface of the projector main body 320. Furthermore, height adjustment screws 325 for adjustment of the height of the projector main body 320, and an exhaust port 326 for a cooling fan are provided.

The projector 301 uses the push-pull-type electrostatic ultrasonic transducers according to the invention as the ultrasonic transducers constituting the ultrasonic speaker, and thus can generate sound signals (sound waves in an ultrasonic frequency band) having high sound pressure in a wide frequency band range. Thus, sound effect equivalent to that of a stereo surround system, 5.1ch surround system or the like can be obtained by controlling the spatial reproduction range of reproduction signals in an audio frequency band through frequency change of carrier waves without necessity for equipping a large-scale sound system which has been required by a projector in the related art. Furthermore, the projector provided according to this embodiment can be easily carried.

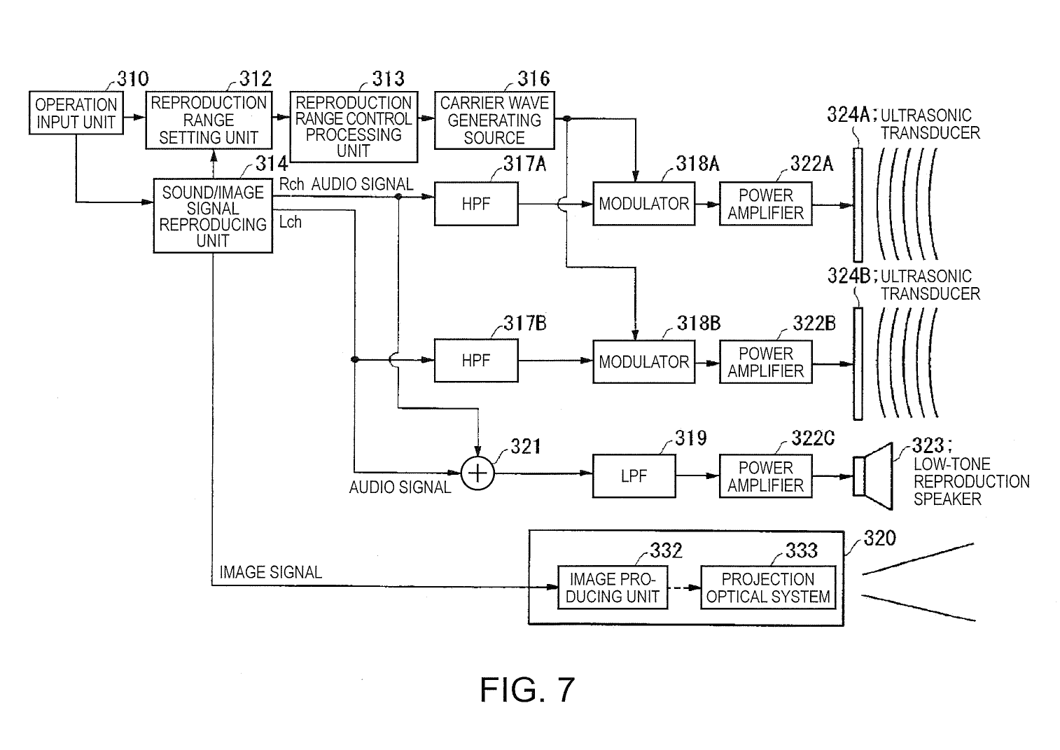

FIG. 7 shows an electric structure of the projector 301. The projector 301 includes the ultrasonic speaker which has an operation input unit 310, a reproduction range setting unit 312, a reproduction range control processing unit 313, an audio/image signal reproducing unit 314, a carrier wave generating source 316, modulators 318A and 318B, power amplifiers 322A and 322B, and the electrostatic ultrasonic transducers 324A and 324B. The projector 301 further includes high-pass filters 317A and 317B, a low-pass filter 319, an adder 321, a power amplifier 322C, the low-tone sound reproduction speaker 323, and the projector main body 320. The electrostatic ultrasonic transducers 324A and 324B are the push-pull-type electrostatic ultrasonic transducers according to the invention.

The projector main body 320 has an image producing unit 332 for producing images, and a projection optical system 333 for projecting produced images on the projection surface. The projector 301 is constituted by the ultrasonic speaker, the low-tone reproduction speaker 323, and the projector main body 320 combined into one body.

The operation input unit 310 has various types of function keys including ten-keys, numeral keys, and a power source key operated to turn on and off power supply. The reproduction range setting unit 312 receives data which specifies a reproduction range of a reproduction signal by key operation of the user through the operation input unit 310. When the data is inputted, the reproduction range setting unit 312 establishes and retains the frequency of carrier waves which specify the reproduction range of the reproduction signal. The reproduction range of the reproduction signal is set by specifying a distance the reproduction signal travels in the emission axis direction from the sound wave emission surfaces of the ultrasonic transducers 324A and 324B.

The reproduction range setting unit 312 can also set the frequency of carrier waves based on a control signal outputted from the audio/image signal reproducing unit 314 according to the contents of image.

The reproduction range control processing unit 313 has functions of referring to the contents of the setting retained in the reproduction range setting unit 312 and controlling the carrier wave generating source 316 such that the frequency of carrier waves generated by the carrier wave generating source 316 can be converted into a frequency within the reproduction range according to the setting.

For example, when the distance discussed above corresponding to the carrier wave frequency of 50 kHz is set as the information retained in the reproduction range setting unit 312, the carrier wave generating source 316 is so controlled as to generate carrier waves having 50 kHz frequency.

The reproduction range control processing unit 313 has a memory section which pre-stores a table indicating the relationship between the frequency of the carrier waves and the distance the reproduction signal travels in the emission axis direction from the sound wave emission surfaces of the ultrasonic transducers 324A and 324B for specifying the reproduction range. The data of the table is obtained by practical measurement of the relationship between the frequency of the carrier waves and the travel distance of the reproduction signal.

The reproduction range control processing unit 313 calculates the frequency of the carrier waves corresponding to the distance information set by referring to the table based on the contents of the setting retained in the reproduction range setting unit 312, and controls the carrier wave generating source 316 such that the carrier waves have the calculated frequency.

The audio/image signal reproducing unit 314 is constituted by a DVD player which uses DVD as image medium, for example. The audio/image signal reproducing unit 314 outputs audio signals of R channel in reproduced audio signals to the modulator 318A via the high-pass filter 317A, audio signals of L channel to the modulator 318B via the high-pass filter 317B, and image signals to the image producing unit 332 of the projector main body 320.

The audio signals of R channel and those of L channel outputted from the audio/image signal reproducing unit 314 are combined by the adder 321, and the combined audio signals are inputted to the power amplifier 322C via the low-pass filter 319. The audio/image signal reproducing unit 314 corresponds to a sound source.

Each of the high-pass filters 317A and 317B has such characteristics as to transmit only frequency components in the middle-tone and high-tone ranges in the audio signals of R channel and L channel. The low-pass filter has such characteristics as to transmit only frequency components in the low-ton range in the audio signals of R channel and L channel.

Thus, the audio signals in the middle-tone and high-tone ranges in the audio signals of R channel and L channel are reproduced by the ultrasonic transducers 324A and 324B, respectively, and the audio signals in the low-tone range in the sound signals of R channel and L channel are reproduced by the low-tone reproduction speaker 323.

The audio/image signal reproducing unit 314 is not limited to the DVD player, but may be a reproduction device which reproduces video signals inputted from the outside. The audio/image signal reproducing unit 314 has a function of outputting a control signal for indicating the reproduction range to the reproduction range setting unit 312 such that the reproduction range of the reproduced sounds can dynamically changes with desirable sound effect according to scenes of images to be reproduced.

The carrier wave generating source 316 has functions of generating carrier waves having frequencies within the ultrasonic frequency band indicated by the reproduction range setting unit 312, and outputting the generated carrier waves to the modulators 318A and 318B.

The modulators 318A and 318B have functions of modulating amplitude of the carrier waves supplied from the carrier wave generating source 316 by the audio signals in the audio frequency band outputted from the audio/image signal reproducing unit 314, and outputting the modulated signals to the power amplifiers 322A and 322B, respectively.

The ultrasonic transducers 324A and 324B are driven based on the modulated signals outputted from the modulators 318A and 318B via the power amplifiers 322A and 322B. The ultrasonic transducers 324A and 324B have functions of converting the modulated signals into sound waves at a finite amplitude level and emitting the sound waves into the medium to reproduce signal sounds (reproduction signals) in the audio frequency band.

The image producing unit 332 has a display such as liquid crystal display and plasma display panel (PDP), a driving circuit for driving the display based on the image signals outputted from the audio/image signal reproducing unit 314, and other components to produce images corresponding to the image signals outputted from the audio/image signal reproducing unit 314.

The projection optical system 333 has a function of projecting images shown on the display onto the projection surface such as screen disposed before the projector main body 320.

The operation of the projector 301 having this structure is now explained. Initially, data (distance information) indicating the reproduction range of the reproduction signals is inputted to the reproduction range setting unit 312 by key operation of the user through the operation input unit 310, and then reproduction command is given to the audio/image signal reproducing unit 314.

The reproduction range setting unit 312 thus establishes the distance information for specifying the reproduction range. The reproduction range control processing unit 313 acquires the distance information established by the reproduction range setting unit 312, refers to the table stored in the memory unit contained in the reproduction range control processing unit 313, and calculates frequency of carrier waves corresponding to the distance information established. Then, the reproduction range control processing unit 313 controls the carrier wave generating source 316 such that carrier waves having the frequency can be generated.

Thus, the carrier wave generating source 316 produces carrier waves having the frequency corresponding to the distance information established by the reproduction range setting unit 312, and outputs the produced carrier waves to the modulators 318A and 318B.

The audio/image signal reproducing unit 314 outputs audio signals of R channel in reproduced audio signals to the modulator 318A via the high-pass filter 317A, audio signals of L channel to the modulator 318B via the high-pass filter 317B, and both audio signals of R channel and L channel to the adder 321. The audio/image signal reproducing unit 314 further outputs image signals to the image reproducing unit 332 of the projector main body 320.

Thus, the audio signals in the middle-tone and high-tone ranges in the audio signals of R channel are inputted to the modulator 318A by the high-pass filter 317A, and the audio signals in the middle-tone and high-tone ranges in the audio signals of L channel are inputted to the modulator 318B by the high-pass filter 317B.

The audio signals of R channel and the audio signals of L channel are combined by the adder 321. The audio signals in the low-tone range in the audio signals of R channel and L channel are inputted to the power amplifier 322C by the low-pass filter 319.

The image producing unit 322 drives the display according to the inputted image signals, and produces and displays images. The images shown on the display are projected on the projection surface such as the screen 302 shown in FIG. 5 by the projection optical system 333.

The modulator 318A modulates amplitude of the carrier waves outputted from the carrier wave generating source 316 by the audio signals in the middle-tone and high-tone range in the audio signals of R channel outputted from the high-pass filter 317A, and outputs the modulated carrier waves to the power amplifier 322A.

The modulator 318B modulates amplitude of the carrier waves outputted from the carrier wave generating source 316 by the audio signals in the middle-tone and high-tone range in the audio signals of L channel outputted from the high-pass filter 317B, and outputs the modulated carrier waves to the power amplifier 322B.

The modulated signals amplified by the power amplifiers 322A and 322B are applied between the upper electrode 10A and the lower electrode 10B of each of the ultrasonic transducers 324A and 324B (see FIGS. 1A and 1B). Then, the modulated signals are converted into sound waves (sound signals) at a finite amplitude level, and emitted into the medium (into the air). Audio signals in the middle-tone and high-tone ranges in the audio signals of R channel are reproduced from the ultrasonic transducer 324A, and audio signals in the middle-tone and high-tone ranges in the audio signals of L channel are reproduced from the ultrasonic transducer 324B.

Audio signals in the low-tone range in the audio signals of R channel and L channel amplified by the power amplifier 322C are reproduced by the low-tone reproduction speaker 323.

As mentioned above, during the propagation of ultrasonic waves emitted into the medium (into the air) from an ultrasonic transducer, the sound speed increases in the high sound pressure part and decreases in the low sound pressure part. As a result, distortion of the modulated waves is caused.

In case of signals (carrier wave) in an ultrasonic band whose amplitude has been modulated by signals in an audio frequency band before emission, signal waves in the audio frequency band used at the time of modulation are separated from the carrier waves in the ultrasonic band due to wave distortion, and thereafter self-demodulated. In this step, the reproduction signals expand in the form of beams due to the characteristics of the ultrasonic waves, and therefore sounds are reproduced in a particular direction in a manner completely different from the case of an ordinary speaker.

The reproduction signals in the form of beams outputted from the ultrasonic transducers 324A and 324B constituting the ultrasonic speaker are emitted toward the projection surface (screen) on which images are projected by the projection optical system 333, and reflected by the projection surface and diffused. In this case, there production range varies with variable beam width (beam expansion angle) and variable distance required until the reproduction signals are separated from the carrier waves in the emission axis direction (normal line direction) from the sound wave emission surfaces of the ultrasonic transducers 324A and 324B in accordance with the frequency of the carrier waves established by the reproduction range setting unit 312.

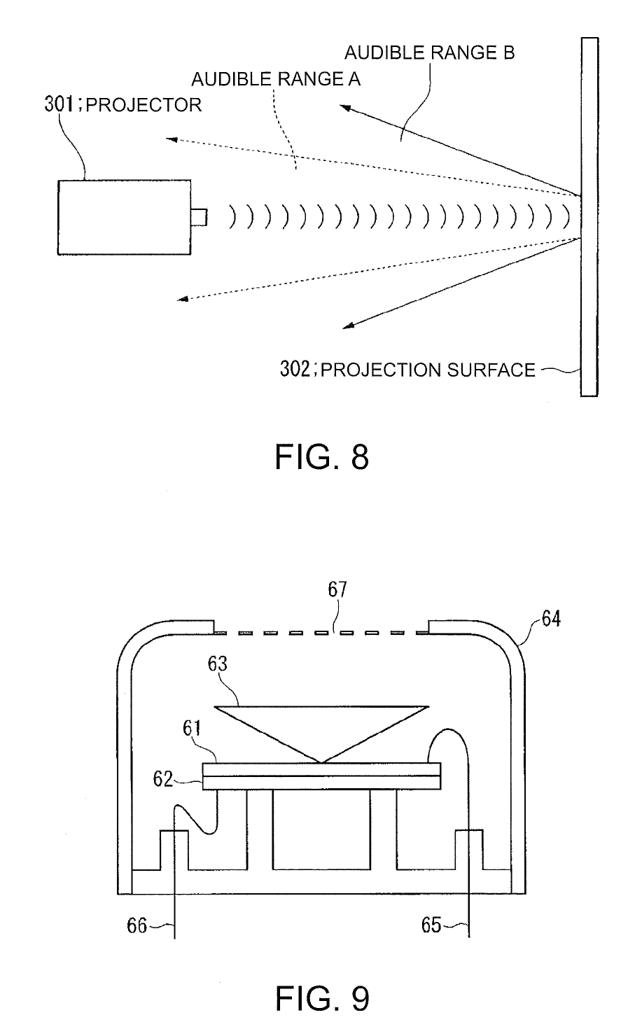

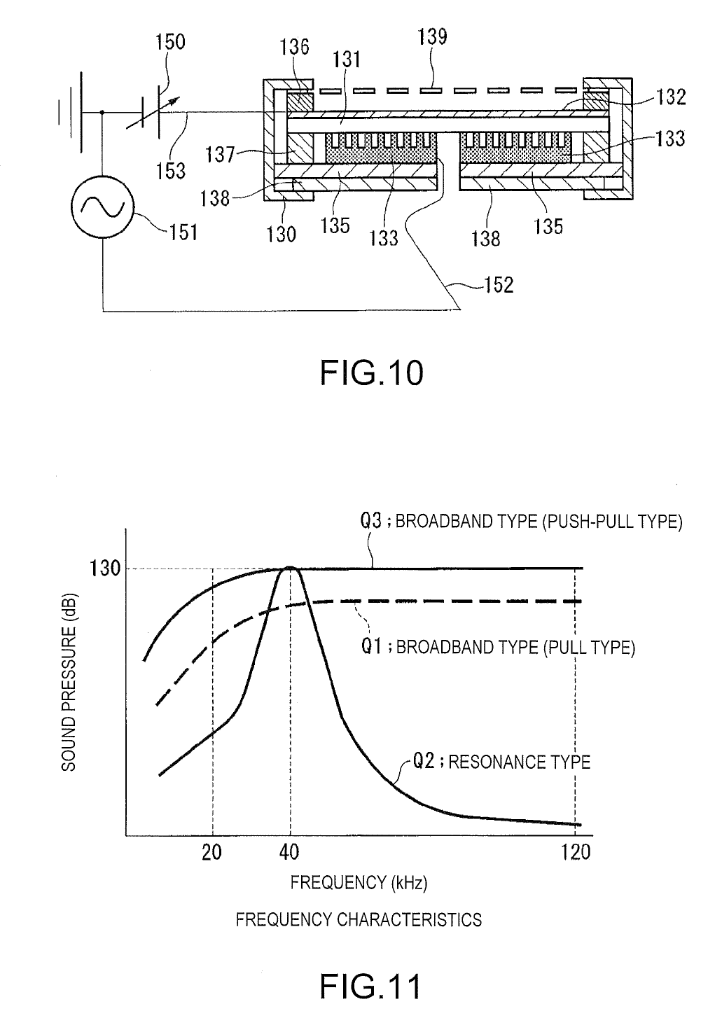

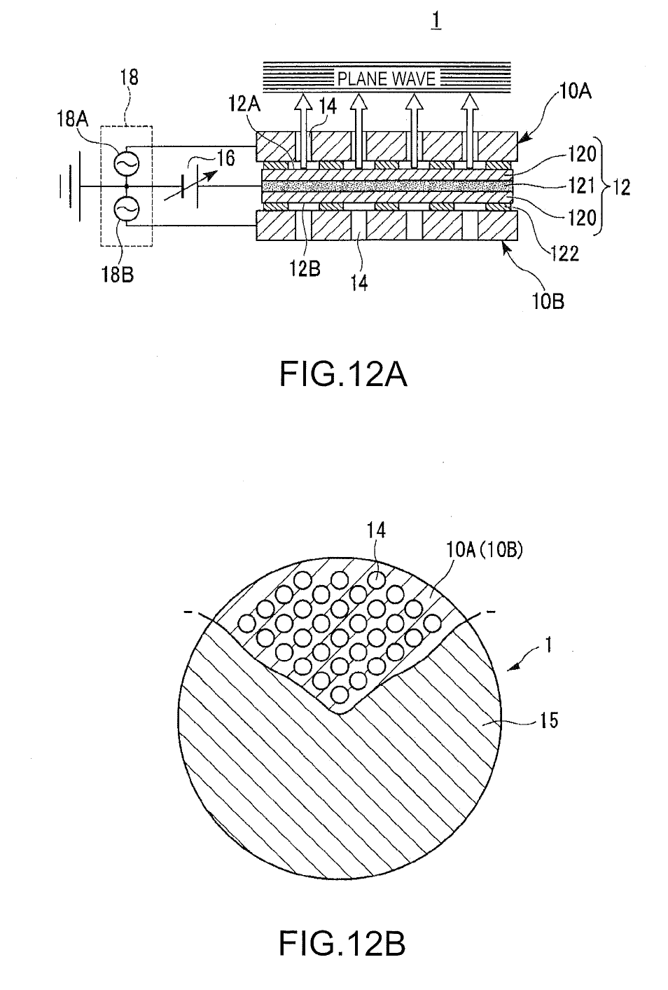

FIG. 8 illustrates a condition of reproduction signals at the time of reproduction generated by the ultrasonic speaker of the projector 301 containing the ultrasonic transducers 324A and 324B. When the carrier frequency established by the reproduction range setting unit 312 is low at the time of operation of the ultrasonic transducers in the projector 301 by the modulated signals produced by modulation of the carrier waves using the audio signals, the distance required until the reproduction signals are separated from the carrier waves in the emission axis direction (normal line direction of sound wave emission surfaces) from the sound wave emission surfaces of the ultrasonic transducers 324A and 324B, that is, the distance to a reproduction point is long.

Thus, the reproduced beams of the reproduction signals in the audio frequency band reach the projection surface (screen) 302 with relatively small expansion, and are reflected by the projection surface 302 in this condition. As a result, the reproduction range becomes an audible range A indicated by dotted arrows in FIG. 8, in which condition the reproduction signals (reproduction sounds) can be heard in a relatively narrow and far area from the projection surface 302.

When the carrier frequency set by the reproduction range setting unit 312 is higher than the above frequency, the sound waves emitted from the sound wave emission surfaces of the ultrasonic transducers 324A and 324B are narrowed compared with the case of the low carrier frequency. In this case, the distance required until the reproduction signals are separated from the carrier waves in the emission axis direction (normal line direction of sound wave emission surfaces) from the sound wave emission surfaces of the ultrasonic transducers 324A and 324B, that is, the distance to the reproduction point is short.

Thus, the reproduced beams of the reproduction signals in the audio frequency band expands before reaching the projection surface (screen) 302, and are reflected by the projection surface 302 in this condition. As a result, the reproduction range becomes an audible range B indicated by solid arrows in FIG. 8, in which condition the reproduction signals (reproduction sounds) can be heard in a relatively wide and near area from the projection surface 302.

As apparent from the above description, the projector according to the invention uses the ultrasonic speaker including the push-pull-type or pull-type electrostatic ultrasonic transducer of the invention, and reproduces sound signals having sufficient sound pressure and broadband characteristics from a virtual sound source formed in the vicinity of the sound wave reflection surface such as screen. Thus, the reproduction range can be easily controlled. Moreover, the directivity of the sound emitted from the ultrasonic speaker can be controlled by dividing the oscillation area of the oscillation film of the electrostatic ultrasonic transducer into plural blocks as described above and controlling the phase of the alternating current signals applied between the electrode layers of the oscillation film and the respective blocks of the oscillation electrode patterns such that predetermined phase difference is produced between the adjacent blocks.

While specific examples according to the invention have been described, the electrostatic ultrasonic transducer and ultrasonic speaker according to the invention are not limited to those examples depicted herein. As such, various modifications and changes may be made without departing from the scope and spirit of the invention.

The ultrasonic transducer according to the embodiment of the invention is applicable to various types of sensor such as distance measuring sensor, and to sound source for directive speaker discussed above, ideal impulse signal generating source, and other devices. Moreover, the ultrasonic transducer according to the embodiment can be appropriately used for ultra-directive sound system and display apparatus such as projector.

The entire disclosure of Japanese Patent Application No. 2006-342295, filed Dec. 20, 2006 is expressly incorporated by reference herein.

What is claimed is:

1. An electrostatic ultrasonic transducer, comprising:
a first electrode having a through hole;
a second electrode having a through hole; and
an oscillation film disposed such that the through hole of the first electrode can be paired with the through hole of the second electrode and sandwiched between the pair of the first electrode and second electrode, the oscillation film having an electrode layer to which direct current bias voltage is applied,
wherein
each of the pair of the electrodes has an electrode portion at a position in the periphery of the through hole, and
an alternating current signal is applied between the pair of the electrodes and the electrode layer of the oscillation film.

2. The electrostatic ultrasonic transducer according to claim 1, wherein:
base members of the pair of the electrodes are made of non-conductive material; and
each of the pair of the electrodes has a step on the periphery of the through hole, and the electrode portion is disposed on the surface of the step opposed to the electrode layer of the oscillation film.

3. The electrostatic ultrasonic transducer according to claim 1, wherein:
base members of the pair of the electrodes are made of conductive material;
each of the pair of the electrodes contains the base member having the convexed electrode portion and the through hole, and a non-conductive member having a through hole, and is constructed by fitting the electrode portion into the through hole of the non-conductive member; and
an alternating current signal is applied between the pair of the electrodes and the electrode layer of the oscillation film.

4. An electrostatic ultrasonic transducer, comprising:
a first electrode having a through hole;
a second electrode having a through hole; and
an oscillation film disposed such that the through hole of the first electrode can be paired with the through hole of the second electrode and sandwiched between the pair of the first electrode and second electrode, the oscillation film having an electrode layer to which direct current bias voltage is applied,
wherein
each of the pair of the electrodes has an electrode portion at a position inside the through hole, and
an alternating current signal is applied between the pair of the electrodes and the electrode layer of the oscillation film.

5. The electrostatic ultrasonic transducer according to claim 4, wherein:
base members of the pair of the electrodes are made of non-conductive material;
each of the pair of the electrodes has the electrode portion disposed on the surface of a bridge-shaped portion of the base member opposed to the electrode layer of the oscillation film; and
an alternating current signal is applied between the pair of the electrodes and the electrode layer of the oscillation film.

6. The electrostatic ultrasonic transducer according to claim 4, wherein:
base members of the pair of the electrodes are made of conductive material;
each of the pair of the electrodes contains the base member having the electrode portion convexed and bridge-shaped at a position opposed to the electrode layer of the oscillation film, and a non-conductive member having a through hole, and is constructed by fitting the electrode portion into the through hole of the non-conductive member; and
an alternating current signal is applied between the pair of the electrodes and the electrode layer of the oscillation film.

7. An ultrasonic speaker, comprising:
an electrostatic ultrasonic transducer including a first electrode having a through hole, a second electrode having a through hole, and an oscillation film disposed such that the through hole of the first electrode can be paired with the through hole of the second electrode and sandwiched between the pair of the first electrode and second electrode, the oscillation film having an electrode layer to which direct current bias voltage is applied, each of the pair of the electrodes having an electrode layer at a position in the periphery of the through hole, and an alternating current signal being applied between the pair of the electrodes and the electrode layer of the oscillation film;
a signal source which generates signal waves in an audio frequency band;
a carrier wave supply unit which generates and outputs carrier waves in an ultrasonic frequency band; and
a modulating unit which modulates the carrier waves by signal waves in an audio frequency band outputted from the signal source,
wherein
the electrostatic ultrasonic transducer is driven by a modulated signal outputted from the modulating unit and applied between the electrodes and the electrode layer of the oscillation film.
